(19) United States
(12) Patent Application Publication
(10) Pub. No.: US 2011/0107375 A1
(43) Pub. Date: May 5, 2011

(54) METHODS AND SYSTEMS FOR PROVIDING A PROGRAM GUIDE FOR NEAR VIDEO ON DEMAND SYSTEMS

(75) Inventors: Thomas Anthony Stahl, Indianapolis, IN (US); Darrel Wayne Randall, Danville, IN (US)

(73) Assignee: Thomson Licensing

(21) Appl. No.: 12/737,140

(22) PCT Filed: Nov. 21, 2008
(86) PCT No.: PCT/US2008/013035

§ 371 Date: Dec. 10, 2010

(51) Int. Cl. H04N 5/445

(52) U.S. Cl. 725/46

(57) ABSTRACT

In accordance with aspects of the present principles, a program guide display for a near video on demand system can be provided. The NVOD system can transmit and/or receive a plurality of duplicate, temporally offset video streams on separate channels to enable viewing of video content at practically any time from its beginning. According to one aspect of the present principles, a channel carrying a program having a start time that coincides with a current time can be selected for display in the program guide while suppressing other NVOD channels carrying duplicate content with offset start times.

### CROSS-REFERENCE

This application claims priority to provisional application entitled “METHOD AND APPARATUS FOR NEAR VIDEO ON DEMAND” with Ser. No. 61/131,530 filed on 10 Jun. 2008, incorporated herein by reference.

### BACKGROUND

Near Video on Demand (NVOD) represents a class of processes and systems by which video content can be distributed to users for viewing at practically any time. NVOD offers an alternative to a true on-demand system and is often employed by satellite and cable television broadcasters, among others, to provide pay-per-view service to customers. The basic premise of NVOD is that multiple copies of video content are transmitted along different channels with offset start times, usually at intervals of between five to twenty minutes. Broadcasters typically inform users of programs and available start times in NVOD systems by utilizing an electronic program guide.

Program guides currently used by broadcasters display all channels on which a program is broadcast and their corresponding start times. A problem with current program guides for NVOD systems is that the short time intervals between start times can make it inconvenient for users to select the best channel to view a desired program. For example, common program guides display hour or half-hour time interval bars to inform users of when a program will start. In NVOD systems, several NVOD channels carrying an NVOD program can appear within one such time interval bar, thereby making it difficult for a user to immediately perceive which channel carries the program with a start time that coincides with the time a user wishes to view the program. Accordingly, there is a need for an efficient means of providing a program guide display that enables a user to select a channel carrying a desired program in an NVOD system.

### SUMMARY

Methods and systems in accordance with various implementations of the present principles address the deficiencies of the prior art by providing a program guide display for Near Video on Demand Systems. According to one aspect of the present principles, one of a plurality of channels on which temporally offset video streams are transmitted can be selected for display in a program guide while suppressing the display of other channels. For example, the channel selected for display can correspond to the channel carrying a program having a start time that coincides with a current time. In this way, a user can simply browse the program guide for desired content and conveniently select the displayed channel to view the content without having to determine which channel in the NVOD system has a current start time for the content.

In one exemplary implementation of the present principles, a method for providing a program guide for a near video on demand system includes transmitting a plurality of duplicate, temporally offset video streams on a corresponding plurality of channels; selecting one of the channels for display in a program guide prior to a user-request for content in the video streams; and providing an indicator of the selected channel for the program guide to enable suppression of non-selected channels.

In an alternate implementation of the present principles, a method for providing a program guide for a near video on demand system includes receiving a plurality of duplicate, temporally offset video streams on a corresponding plurality of channels; selecting one of the channels for display in a program guide prior to a user-request for content in the video streams; and displaying an indicator of the selected channel in the program guide and suppressing display of indicators of non-selected channels.

In a different implementation of the present principles, a system for providing a program guide for a near video on demand system includes a content server and system controller configured to transmit a plurality of duplicate, temporally offset video streams on a corresponding plurality of channels; and a receiver configured to receive the video streams and select one of the channels for display in a program guide prior to a user-request for content in the video streams and configured to display an indicator of the selected channel in the program guide and suppress display of indicators of non-selected channels.

### BRIEF DESCRIPTION OF THE DRAWINGS

The teachings of the present invention can be readily understood by considering the following detailed description in conjunction with the accompanying drawings, in which:

FIG. 1 is a high level block diagram of an exemplary NVOD system in accordance with one implementation of the present principles.

FIG. 2 is a high level flow diagram of an exemplary method for providing a program guide for a near video on demand system.

It should be understood that the drawings are for purposes of illustrating the concepts of the present principles and are not necessarily the only possible configuration for illustrating the present principles. To facilitate understanding, identical reference numerals have been used, where possible, to designate identical elements that are common to the figures.

### DETAILED DESCRIPTION

The present principles include systems and methods for providing a program guide interface in NVOD systems. Although the present principles are described herein below primarily within the context of an airplane multimedia distribution system, the specific implementations of the present principles should not be treated as limiting the scope of the invention. It is appreciated by those skilled in the art and informed by the teachings of the present principles that the concepts of the present invention can be advantageously applied in other types of multimedia content distribution systems. For example, the concepts of the present principles can be implemented in satellite broadcasting systems, cable television broadcasting systems and the like.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and implementations of the present principles, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it is appreciated by those skilled in the art that the block diagrams presented herein represent conceptual views of illustrative system components and/or circuitry embodying the principles of the invention. Similarly, it is appreciated that any flow charts, flow diagrams, state transition diagrams, pseudocode, and the like represent various processes which can be substantially represented in computer readable media and so executed by a computer or processor, whether or not such computer or processor is explicitly shown.

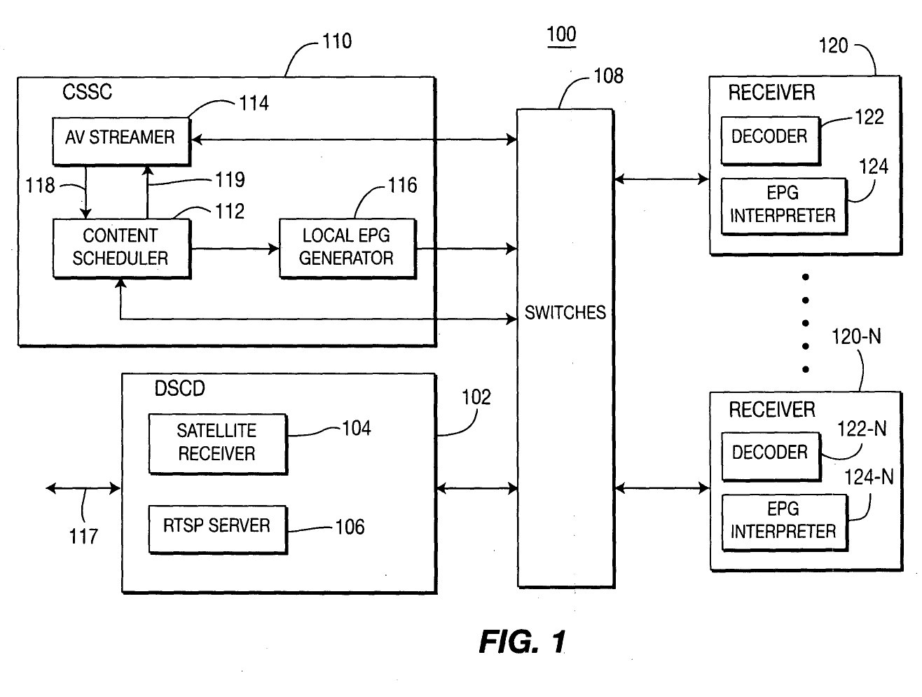

Referring now in specific detail to the drawings in which like reference numerals identify similar or identical elements throughout the several views, and initially to FIG. 1, a high level block diagram of an exemplary NVOD video content distribution system 100 for providing a program guide for NVOD content in accordance with one exemplary implementation of the present principles is illustrated. System 100 can include a Digital Satellite Concentrator and Distributor (DSCD) 102, a Content Server and System Controller (CSSC) 110, Ethernet switches 108 and a series of receivers 120-120-N, including decoders 122-122N and EPG interpreters 124-124-N, respectively. The receivers 120 can, for example, respectively service video displays for each passenger seat.

The DSCD 102 can act as a satellite gateway for the content distribution system. For example, DSCD 102 can receive video content data streams and corresponding program guide information from a satellite service provider (not shown) along line 117 through satellite receiver 104. Functions of the DSCD 102 can include modifying received packets to indicate the presence of a local network so that a receiver 120 can acquire a local guide. Additionally, the DSCD 102 can include a Real Time Streaming Protocol (RTSP) server 106 to service receivers 120 by intercepting local content tuning requests and responding to the receivers 120 by sending corresponding local multicast group addresses on which requested video streams can be found. Here, the RTSP server 106 can intercept tuning requests internally and distinguish between tuning requests for local content and tuning requests for satellite or external content. For external content tuning requests, the RTSP server 106 can transform the requests into RTSP requests. Further, audio/video content and guide information received via satellite can be sent by the DSCD 102 to the CSCC 110 on an Audio/video Digital Satellite Service (DSS) Transport Stream (TS) through switches 108.

The CSSC 110 can be the primary system controller that is responsible for local content insertion. For example, local content can include a video instructing passengers of customs regulations or a video instructing passengers of safety precautions. However, it should be understood that in other implementations, such as cable television systems, local content insertion can include insertion of other types of content, such as commercials and advertisements, for example, within audio/video (AV) streams. Further, it should be noted that local content can also comprise entertainment programs or motion pictures stored within CSSC 110. Components of the CSSC 110 can include, inter alfa, an AV Streamer or Data Pump 114, a Content Scheduler 112 and a Local Electronic Program Guide (EPG) Generator 116, each of which is discussed herein below.

The AV Streamer 114 can be configured to generate and stream AV content on the local network at a proper rate. For example, the AV Streamer 114 can aggregate and encapsulate packets from an AV DSS Transport Stream into a Real-time Protocol (RTP)/User Datagram Protocol (UDP)/Internet Protocol (IP) stream. In some implementations of the present principles, the AV Streamer 114 can act as the front end for user input. For example, the AV Streamer 114 can be configured to monitor XML files, each corresponding to a plurality of receivers 120, to service any channel request changes. In addition, the AV streamer 114 can parse XML files and supply guide generation related inputs to the Local EPG Generator 116, which is discussed in more detail below. In general, the AV Streamer 114 can be controlled through a Local Guide XML file generated by the Content Scheduler 112, which can control user-access to video streams, insertion of local content, and EPG displays, as discussed below.

Further, the AV Streamer 114 can inform the Content Scheduler 112 of the content currently playing, when certain content has finished playing, and the state of AV streamer 114 through a Now Playing (NP) XML File. The playing status of content can be useful for pausing or un-pausing content for the display of locally inserted content, as discussed below with respect to the Content Scheduler 112. The format of the NP XML File can include a base time, a timestamp and a channel listing, which can reference all channels. The channel listing can include a channel name, channel objects, which can include a user-recognizable number, name and logo, and program information. The base time can indicate a time by which all program start times and end times or other events are measured. For example, a base time can be Jan. 7, 1980 12:00 am and all program start and end times can correspond to the total number of seconds after this time. The AV Streamer 114 can further include an XML parser (not shown) that can parse the Local Guide XML file for control purposes. Alternatively, the XML parser can be independent of the AV Streamer 114 and can parse the Local Guide XML file for both the AV Streamer 114 and the Local EPG Generator 116. The AV Streamer 114 can monitor the Local Guide XML files for any changes to the status of channels or programs. For example, if access to a channel is denied or granted to a receiver, the AV Streamer 114 can monitor the Local Guide XML file for changes, determine that an access tag for a channel has been modified and thereby institute a denial or grant of access to a receiver. It should be noted that in one or more implementations of the present principles, Content Scheduler 112 can employ a separate communications channel to control the EPG interpreter 124 of receiver 120 so that only programs in the EPG that a receiver 120 is authorized to view are displayed. In addition, the separate communications channel can be utilized by the Content Scheduler 112 to control which channels a particular receiver can tune to for the display of video content. Further, the Content Scheduler 112 can coordinate receivers and control which channels are displayed in a program guide at a receiver by employing unique channel object identifiers to reference channels.

As stated above, the Content Scheduler 112 can control user-access to video streams, insertion of local content, and EPG displays by employing a Local Guide XML file. The Local Guide XML file can include a base time, channel listing, program listings and related information, optional pause functionality for channels, file names of files and schedules, which can be offset by a base time. The pause functionality can be used to pause a channel for the insertion of forced local content and to unpause the channel when the display of the forced local content is finished, as discussed more fully below. As stated above, the AV Streamer 114, as well as the Local EPG Generator 116, can monitor the Local Guide XML file for changes and institute any corresponding status changes. One example of a portion of an XML file for a channel and corresponding programs is illustrated in Table 1 below.

TABLE 1

<channel major=1 minor=1>

<channel_name>MISCMOVIE</channel_name>
<object_ID>0xFFFFF000</object_ID)
<channel_description>Movie channel</channel_description>
<logo_index>56</logo_index>
<category>Action</category>
<category>Movie</category>
<audio>English</audio>
<audio>French</audio>
<audio>Spanish</audio>
<program>

<name>Norbit</name>
<description>Starring Eddie Murphy</description>
<filename>norbit_trailer.mpg</filename>

</program>
<program>

<time_start>0</time_start>
<time_end>1800</time_end>
<name>TheCleaner</name>
<description>A Must see comedy.</description>
<rating>PG</rating>
<filename>thecleanertrailer.mpg</filename>

</program>
<program>

<time_start>1800</time_start>
<time_end>3600</time_end>
<name>NightAtTheMuseum</name>
<description>Ben Stiller in the best comedy of the
year.</description>
<rating>G</rating>
<filename>nightatthemuseumtrailer.mpg</filename>

</program>
<program>

<time_start>3600</time_start>
<time_end>10800</time_end>
<name>Spiderman_3</name>
<description>SpiderMan returns...</description>
<rating>G</rating>
<fllename>spiderman_3_trailer.mpg</filename>

</program>

</channel>

As stated above, the Content Scheduler 112 can be kept abreast of the status of video streams through a Now Playing XML file generated by the AV Streamer 114. For example, the Content Scheduler 112 can receive a signal along line 118 indicating that the Now Playing XML file has changed and verify that locally inserted content is streamed by reading the Now Playing XML file. Similarly, the AV Streamer 114 can receive a signal along line 119 indicating that a Local Guide XML file has been changed. Another functions of the Content Scheduler 112 includes coordinating actions with receivers 120 by sending control commands such as force tuning the decoders 122 within the receivers 120. Force tuning can be performed by the Content Scheduler 112, for example, to force decoders 122 to tune to a channel transmitting locally inserted content and to force decoders 122 to tune to a previously tuned channel when the locally inserted content has finished playing.

Local XML Files generated by the Content Scheduler 112 can be provided to the Local EPG Generator 116. The Local EPG Generator 116 can employ an XML parser to convert XML format data into one or more EPG streams comprising one or more of channel objects, schedule objects including portions of schedules for programming sources, program objects including information about program content, and update list objects, which can list all recently changed or otherwise important objects in a stream. The EPG streams can be created in real time from information provided in the Local Guide XML file. In one implementation of the present principles, a Fast Load EPG Stream and an Update Carousal EPG Stream can be generated. The Update Carousal EPG Stream can include channel objects, schedule objects, program objects and update list objects. Conversely, the Fast Load EPG stream can include channel objects and update list objects. Because program and schedule objects typically change at a low rate, bandwidth can be conserved by the transmitting the two data streams at different rates. For example, in accordance with an implementation of the present principles, an EPG data gram is sent every two seconds, where for every three fast load object datagrams, one carousel datagram is sent.

The EPG streams, in addition to AV streams, can be transmitted to receivers 120 through switches 108. Receiver 120 can include a decoder 122 that is configured to decode AV streams and EPG streams. Receiver 120 can further include an EPG interpreter 124 to parse EPG information for display to a user. Additionally, the state of the receiver 120 can be communicated to the Content Scheduler 112 through a separate communications channel within the network of system 100.

It should be noted that one of ordinary skill in the art can extend and apply the concepts disclosed herein in other environments. For example, the DSCD 102 and CSSC 110 can be implemented at service provider stations of satellite or cable television broadcasters and the receivers 120-120-N can be implemented in the homes of customers. In addition, the switches can be replaced by satellite transmitters and receivers and/or a network of coaxial cables and switches, for example.

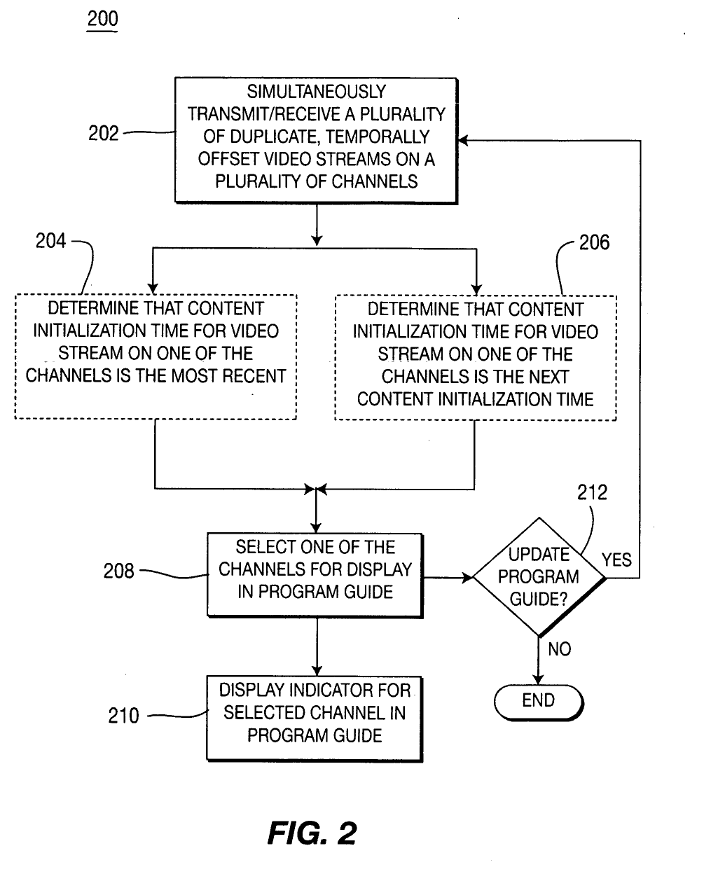

Referring now to FIG. 2 with continuing reference to FIG. 1, a high level flow diagram of a method 200 for providing a program guide for a near video on demand system in accordance with one exemplary implementation of the present principles is illustrated.

Method 200 can begin at step 202 in which a plurality of duplicate, temporally offset video streams are simultaneously transmitted and/or received on a plurality of channels. As discussed above, in an NVOD system, multiple copies of video content can be simultaneously transmitted along several, separate channels to enable a user to view a program from its beginning at virtually any time. For example, data content can be transmitted along each channel such that the beginning of a program on each of the NVOD channels carrying the program is serially offset by a time interval, such as five minutes. For example, channel 1 can carry a movie A such that its start time is 5:00 pm, channel 2 can carry movie A such that its start time is 5:05 pm, etc. It should be understood that other time intervals can be employed. It should also be noted that the content on a single channel can be repeatedly looped. Further, the time to which the beginning of certain content, e.g., 5:00 pm or 5:05 pm, discussed above, transmitted in an NVOD video stream coincides is referred to herein as a “content initialization time.” Thus, a plurality of different channels, respectively carrying duplicate, temporally offset video streams, have different corresponding content initialization times.

In one implementation of the present principles, the plurality video streams can be transmitted by CSSC 110 and received by decoders 120. Further, the number of NVOD channels can be 50 stored AV channels in addition to a real-time map channel, a real-time AV input, and several channels for live feeds. The duplicate, temporally offset NVOD streams discussed above can be transmitted in a variety of ways. For example, one live stream of video content can be received at the DSCD 102 and transmitted to the CSSC 110. The CSSC 110 can duplicate and temporally offset the streams for transmission on a plurality of channels to decoders 120. In another example, NVOD streams can be sent directly to the decoder DSCD 102. Duplicate, temporally offset streams can be received by the DSCD 102 along different channels, transmitted to the CSSC 110 and sent to the receivers 120 along different channels. Alternatively, the duplicate, temporally offset streams can be transmitted to the receivers 120 from the DSCD 102. Furthermore, the NVOD content can be stored in the CSSC 110 and can be duplicated and temporally offset by the CSSC 110 for transmission on a plurality of channels to decoders 120. For example, the temporally offset streams can be generated by employing the Local Guide XML file to direct the AV Streamer 114 to begin streaming an NVOD content file at different times.

As stated above, EPGs employed by current NVOD systems display all channels on which a program is broadcast with their corresponding start times, which can make it inconvenient for users to select the best channel on which to view a program due to long time interval bars with a short time offset between the NVOD streams for the same program. In accordance with an aspect of the present principles, an NVOD system can automatically display the best channel for viewing a program without user-intervention.

In method 200, one of many determination steps can be performed in furtherance of displaying the best channel for viewing a program. For example, at step 204, the most recent content initialization time for a video stream transmitted on one of the plurality of channels can be determined. In step 204, the most recent content initialization time is the closest content initialization time that has passed just prior to a current time. Alternatively, step 206 can be performed. At step 206, the next content initialization time for a video stream transmitted on one of the plurality of channels can be determined. In step 206, the next content initialization time is the immediate, next content initialization time that is later than a current time. It should be understood that steps 204 and 206 can be performed by the Content Scheduler 112 in the CSSC 110 and/or any one or more of receivers 120. For example, in an implementation of the present principles, the EPG can be generated locally at a receiver 120 by utilizing any received start time information for various NVOD channels that can be transmitted in parallel with AV streams.

At step 208, one of the NVOD channels can be selected for display in a program guide. For example, the channel selected can be a channel carrying the video stream determined in any one of steps 204 and 206. The selection can be implemented in various ways. For example, where the receiver performs determining steps 204-206, the receiver can simply select the channels determined in those steps. Further, in another exemplary implementation of the present principles, the Content Scheduler 112 can employ the Local Guide XML file to select NVOD channels for display in EPGs. Thereafter, the receiver 120 can select the determined channel for display in an EPG in response to receiving control information from the content scheduler 112 across the network and through an application program interface. Alternatively, the local EPG generator can include the selection information in an EPG stream by parsing the XML file and the receiver can select the determined channel by reading the EPG stream using EPG interpreter 124.

In accordance with one aspect of the present principles, objects in the Local Guide XML file can be tagged so that their corresponding channels would not visibly appear in an EPG. One exemplary guide tag can include <channel major=1 minor=1 guide=NO>, where the channel is suppressed or not displayed in the EPG if the guide tag is designated false and the channel is displayed in the EPG if the guide tag is designated true. Another tag can include a separate “guide inclusion indicator” tag.

However, while employing the tags discussed above can prevent the channel from being viewed in the EPG, in some existing receivers, the receivers can not be able to stay tuned to the channel as the tag gets updated. For example, as discussed below, the determination steps 204-206, selection step 208, and/or display step can be performed dynamically as time passes. Thus, as a new channel is selected for display with the passage of time, some receivers can not continue to tune to a channel if it is de-selected or not selected for display in the EPG. In another implementation of the present principles, an already existing tag can be employed to both display and suppress a channel in an EPG and, at the same time, enable authorized users to view the channel even if it is suppressed in the EPG. Such a tag can include a purchase status tag.

By employing a purchase status tag, a virtual channel can be suppressed in the EPG but remain tunable to an authorized user. Further, use of a purchase status tag can enable inclusion of program related information in a channel banner when the channel is tuned even if the channel is suppressed in the EPG. For example, if a guide tag is set to false through dynamic selection discussed above or otherwise set to false, a purchase status can be updated to enable a user to view the program despite the guide tag false designation. For example, the purchase status can be set to “purchased; video allowed.” If the purchase status has any other value, then tuning can be disallowed. In accordance with aspects of the present principles, authorizing a user to view a program, for example, by setting the purchase status tag to “video allowed,” can be based on any one or more payment states. Payment states can include “free to view,” “free preview period but payment required,” “payment required, video disallowed,” “payment no longer allowed, video disallowed,” and “has been purchased.”

It should be understood that in one or more implementations of the present principles the “purchase status” can be communicated to the receivers directly from the Content Scheduler 110 through a separate communications channel. In addition, purchase status information transmitted through a separate communications channel can be utilized with a guide tag of the Local Guide XML file. Here, the guide tag of the Local Guide XML file can be employed to control the content of the streams generated by the AV Streamer 114 and the content of the EPG streams generated by the Local EPG Generator 116. A guide tag in the Local Guide XML file in combination with the purchase status information can enable dynamic selection of an NVOD channel for display in an EPG over time and permit the display of NVOD content transmitted on channels even if the channels are suppressed within the EPG.

Table 2, provided below, lists one exemplary group of guide tag and purchase status value combinations and their corresponding effects at a receiver for a particular channel. A “Yes” designation in the “Display in EPG” column indicates that the channel is displayed in the EPG while a “No” designation indicates that the channel is not displayed in the EPG. Similarly, a “Permitted” designation in the “Permit user to tune to channel” column indicates that the channel can be tuned to by a user, for example, when “surfing” channels, while a “Not permitted” designation indicates that the channel can not be tuned to by a user. When a “Not permitted” designation is applied, the corresponding channel can be skipped during user-“surfing.” If a user is permitted to tune to a channel, the display of the video content on the corresponding channel can be based on the purchase status information. For example, if the purchase status is “payment required” or “payment no longer allowed,” then the video is blocked. If the purchase status is “purchased,” “free to view,” or “free preview,” then the video is displayed.

TABLE 2

| | Purchase | | | Permit user |
|---|---|---|---|---|
| Guide Tag | Status | Channel State with respect to | Display in | to tune to |
| Value | Information | user | EPG | channel |
| False | Payment | Channel is currently unused. | No | Not permitted |
| | required | | | |
| False | Purchased; | Channel is not selected for | No | Permitted |
| | Free to view; | display in the EPG but its | | |
| | Free preview | content is transmitted after a | | |
| | | purchase or if the content is | | |
| | | free to view. | | |
| False | Payment no | Channel is not selected for | No | Not permitted |
| | longer | display in the EPG but content | | |
| | allowed | is transmitted and particular | | |
| | | user has not purchased content. | | |
| True | Payment | Channel is selected for display | Yes | Permitted |
| | required | in the EPG and its content has | | |
| | | not been purchased by a user. | | |
| True | Purchased | Channel is selected for display | Yes | Permitted |
| | | in the EPG and its content has | | |
| | | been purchased by a user. | | |
| True | Free to view; | Channel is selected for display | Yes | Permitted |
| | Free preview | in the EPG and purchase of its | | |
| | | content is not required. | | |

At step 210, an indicator for the selected channel can be displayed in the program guide along with a description of the channel's video content. For example, an indicator can constitute an indication of the channel number of the selected channel and/or it can constitute an icon representing the streamed video content that is user-selectable for the display of the video stream content transmitted on the selected channel. In one implementation of the present principles, a single channel number or indicator, referred to herein as “the virtual program channel,” can represent the selected channel. As mentioned above, the selected channel can change dynamically as time passes. Thus, the channel with which the virtual program channel is associated can change over time without any user-awareness. Further, the receiver 120 or the local EPG generator 116 can be configured to display the electronic program guide and to associate the selected channel with the virtual program channel.

Of the plurality of channels on which duplicate, temporally offset programs or video content is transmitted, the selected channel appears in the program guide display as the only channel representing the video content. The non-selected channels are suppressed in the display in that they are not presented in the program guide. For example, in an exemplary implementation, six channels can be allocated to an NVOD program, where the start time of each program is serially delayed at ten minute intervals. For example, they can appear in slots three through eight in the Local Guide XML file. During the first 10 minutes, the program in channel 3 is active while channels 4 though 8 can show their default program, which can comprise video content that is near its end or its middle, for example. Channel 3 can appear in the visible EPG with an NVOD description stating that programs start on 10 minute boundaries. If the user selects the channel or program, then the stream on channel 3 is displayed. After 10 minutes, the system state can be modified such that channel 3 does not appear in the visible program guide and is replaced in the program guide by channel 4. The AV stream associated with channel 4 can start at the time indicated in the Local Guide XML file. At this point, if a user selects the channel or program, then the stream on channel 4 is displayed. The process can repeat so that all 6 channels, 3 though 8, have been selected for display in the program guide. It should be understood that although channels do not appear in the EPG, their corresponding video streams can still be transmitted through them.

At step 212, it can be determined whether the program guide should be updated. If the program guide should be updated, then a determination step, 204 or 206, and step 208 can be performed. Otherwise, the process can end. For example, after a certain time period, which can correspond to the content initialization offset between video streams transmitted on corresponding NVOD channels, a determination step, 204 or 206, and the selection step 208 can be repeated to update the selected channel for display in the EPG. In this way, determination and selection of the channel for display in the program guide can be performed dynamically as time passes. For example, if step 204 is performed, step 204 and/or step 208 can be performed dynamically as most the recent content initialization time varies. Similarly, if step 206 is performed, step 206 and/or step 208 can be performed dynamically as the next content initialization time after a current time varies. It should be understood that method 200 is not limited to performing only one of steps 204 and 206. For example, steps 204 and 206 can be performed simultaneously with respect to different sets of NVOD channels transmitting different video content. In addition, steps 204 and 206 can be performed for the same set of NVOD channels at different passes or iterations of method 200.

It should be noted that method 200 can be implemented such that the selected channel can be updated until a power off command, at which point the process can end. It should also be noted that step 202 can be performed continuously while process 200 is implemented.

Further, it should be understood that any one or more of the steps of method 200 can be performed automatically and prior to any user-request for content. As stated above, one problem associated with current program guides in NVOD systems is that user-determination of the best channel to view can be inconvenient to the user. For example, due to large time interval bars within a program guide and short time offsets between the NVOD streams, it can be difficult for a user to determine the channel on which video content is currently starting. In accordance with one or more implementations of the present principles, an EPG can be configured to display the channel on which video content is currently starting prior to any user-request for content. For example, after steps 204/206 and step 208 are performed, a user can select a program guide display option to view available programs through the program guide. Thereafter, to inform the user of viewable programs, the program guide displays an indicator for an automatically selected NVOD channel corresponding to the channel transmitting a video stream with a content initialization time that best coincides with the current time. At the same time, indicators of other non-selected NVOD channels can be suppressed or not shown in the program guide. The user can simply select the displayed indicator and view the corresponding program virtually from its beginning. Thus, aspects of the present principles provide an efficient means for displaying a program guide display that enables a user to select a channel carrying a desired program in an NVOD system.

Having described preferred implementations for systems and methods for providing a program guide for a near video on demand system (which are intended to be illustrative and not limiting), it is noted that modifications and variations can be made by persons skilled in the art in light of the above teachings. It is therefore to be understood that changes can be made in the particular implementations of the present principles disclosed which are within the scope and spirit of the invention as outlined by the appended claims. While the forgoing is directed to various implementations of the present principles, other and further implementations of the present principles can be devised without departing from the basic scope thereof.

1. A method for providing a program guide for a near video on demand system comprising:
selecting one of a plurality duplicate, temporally offset video streams on a plurality of corresponding channels for display in a program guide responsive to a user-request for content in the video streams; and
providing an indicator of the selected channel for the program guide to enable suppression of displaying non-selected channels.

2. The method of claim 1, further comprising:
determining that a content initialization time of one of the video streams is a most recent content initialization time of the plurality of video streams, wherein the selected channel carries the video stream with the most recent content initialization time.

3. The method of claim 2, wherein the selecting is performed dynamically as the most recent content initialization time varies.

4. The method of claim 1, further comprising:
determining that a content initialization time of one of the video streams is a next content initialization time after a current time, wherein the selected channel carries the video stream with the next content initialization time.

5. The method of claim 4, wherein the selecting is performed dynamically as the next content initialization time after a current time varies.

6. The method of claim 1, wherein the indicator of the selected channel is user-selectable for the display of the video stream transmitted on the selected channel.

7. The method of claim 1, wherein said indicator is a channel identifier.

8. The method of claim 1, wherein the selecting further comprises updating an Extensible Markup Language file tag.

9. A method for providing a program guide for a near video on demand system comprising:
receiving a plurality of duplicate, temporally offset video streams on a corresponding plurality of channels;
selecting one of the channels for display in a program guide prior to a user-request for content in the video streams; and
displaying an indicator of the selected channel in the program guide and suppressing display of indicators of non-selected channels.

10. The method of claim 9, further comprising:
determining that a content initialization time of one of the video streams is a most recent content initialization time of the plurality of video streams, wherein the selected channel carries the video stream with the most recent content initialization time.

11. The method of claim 10, wherein the selecting is performed dynamically as the most recent content initialization time varies.

12. The method of claim 9, further comprising:
determining that a content initialization time of one of the video streams is a next content initialization time after a current time, wherein the selected channel carries the video stream with the next content initialization time.

13. The method of claim 12, wherein the selecting is performed dynamically as the next content initialization time after a current time varies.

14. The method of claim 9, wherein the selecting further comprises updating an Extensible Markup Language file tag.

15. The method of claim 9, wherein the selecting is performed through an application program interface within a receiver.

16. A system for providing a program guide for a near video on demand system comprising:
a receiver configured to receive simultaneously a plurality of duplicate, temporally offset video streams on a transmitted on a plurality of corresponding channels; and select one of the channels for display in a program guide prior to a user-request for content in the video streams and configured to display an indicator of the selected channel in the program guide and suppress display of indicators of non-selected channels.

17. The system of claim 16, wherein the receiver is further configured to determine that a content initialization time of one of the video streams is a most recent content initialization time of the plurality of video streams, wherein the selected channel carries the video stream with the most recent content initialization time.

18. The system of claim 17, wherein the receiver is further configured to dynamically select one of the channels for display in the program guide as the next content initialization time after a current time varies.
